(19) United States
(12) Patent Application Publication
(10) Pub. No.: US 2026/0029580 A1
(43) Pub. Date: Jan. 29, 2026

(54) METHOD AND SYSTEM FOR LASER CLEAVING OPTICAL FIBERS

(71) Applicant: CORNING RESEARCH & DEVELOPMENT CORPORATION, Corning, NY (US)

(72) Inventors: Xin Chen, Painted Post, NY (US); Jason Edward Hurley, Corning, NY (US); Jie Liu, Painted Post, NY (US); John Lawrence Nord, Painted Post, NY (US); Craig John Mancusi Ungaro, Corning, NY (US); Qi Wu, Painted Post, NY (US); Lei Yuan, Painted Post, NY (US)

(21) Appl. No.: 19/250,521

(22) Filed: Jun. 26, 2025

Related U.S. Application Data
(60) Provisional application No. 63/675,774, filed on Jul. 26, 2024.

(51) Int. Cl. G02B 6/25

(52) U.S. Cl. CPC G02B 6/25

(57) ABSTRACT

A method and system for laser cleaving an optical fiber. The method includes applying a non-diffracting beam to the optical fiber to create a plurality of perforations therein by pulsing and scanning the non-diffracting beam across the optical fiber. The perforations form a perforation plane in the optical fiber across which the optical fiber is separated to form a cleaved fiber end face. The system includes a laser, an optical assembly that receives a laser beam from the laser and outputs the non-diffracting beam, and one or more translation stages configured to scan the non-diffracting beam across the optical fiber such that the plurality of perforations are created in the optical fiber to define the perforation plane. Penetration depth of the non-diffracting beam is controlled by adjusting one or more parameters of the non-diffracting beam to avoid damage to the core region of the optical fiber.

### PRIORITY APPLICATION

This application claims the benefit of priority of U.S. Provisional Application No. 63/675,774, filed on Jul. 26, 2024, the content of which is relied upon and incorporated herein by reference in its entirety.

### TECHNICAL FIELD

This disclosure relates generally to optical fibers, and more particularly to a method and system for laser cleaving large diameter specialty optical fibers such as hollow-core optical fibers.

### BACKGROUND

Optical fibers are useful in a wide variety of applications, including the telecommunications industry for voice, video, and data transmissions. Benefits of optical fibers include wide bandwidth and low noise operation. Traditional optical fibers include a solid-core and a solid cladding that surrounds the core. The core and cladding are typically made of fused silica doped so that the core has a higher index of refraction than the cladding. The core and cladding of the optical fiber are thereby configured to define an optical waveguide that generally confines optical beams propagating through the optical fiber to a region of the optical fiber within and immediately adjacent to the core.

Hollow-core optical fibers are a relatively new type of optical fiber that guides light through a hollow air-filled core rather than through a solid silica core. As a result, hollow-core optical fiber has an effective index of refraction similar to that of air. Accordingly, light propagates through hollow-core optical fiber at essentially the same speed as light in vacuum (300,000 km/sec), which is about 50% faster than the speed at which light typically propagates through solid-core optical fiber (200,000 km/s). Thus, hollow-core optical fiber offers significantly reduced latency compared to solid-core optical fiber. Due to the improvements in signal loss and useable wavelengths resulting from recent research and development, hollow-core optical fiber is becoming increasingly attractive for use in commercial applications.

The unique features of hollow-core optical fibers have the potential to provide significant advantages in a variety of applications. However, hollow-core optical fibers have certain drawbacks that have so far limited their use. One challenge that continues to impede the use of hollow-core optical fibers is the difficulty in forming connections between hollow-core optical fibers and existing optical systems that mostly use solid-core optical fibers, e.g., standard single mode optical fiber. Connectors are challenging and the exposed hollow-core optical fiber is susceptible to mechanical damage or contamination by a humid environment. Therefore, a permanent hermetic interconnection solution is often required. A common way to create such a permanent interconnection between two optical fibers is through fusion splicing. The performance of a fusion spliced connection is directly impacted by the quality of the end faces of the optical fibers. Particularly, the end faces of the optical fibers should be perpendicular to the optical axis of the optical fiber, or at well-defined angles relative to the optical axis, and have mirror quality surfaces.

End faces are typically formed in optical fibers by a process known as cleaving. However, cleaving does not always produce high quality cleaved fiber end faces. With solid-core optical fibers, poor quality end face surfaces can be corrected by polishing. However, polishing typically cannot be performed on hollow-core optical fibers due at least in part to the possibility of contamination and damage to the core region of the hollow-core optical fiber during polishing.

Thus, there is a need in the fiber optic industry for methods and systems for cleaving optical fibers, and particularly large diameter specialty optical fibers such as hollow-core optical fibers, that produce high quality cleaved fiber end faces that do not require further processing, such as polishing.

### SUMMARY

In an aspect of the disclosure, an improved method of cleaving an optical fiber is disclosed. The method includes generating a non-diffracting beam configured to perforate the optical fiber, scanning the non-diffracting beam across the optical fiber such that a plurality of perforations are created in the optical fiber that define a perforation plane in the optical fiber, and applying a force across the perforations such that the optical fiber breaks along the perforation plane to form a cleaved fiber end face.

In one embodiment of the disclosed method, the non-diffracting beam may be a Bessel beam, and generating the non-diffracting beam may include generating a primary Bessel beam in an object space by passing a laser beam through an axicon lens having a deflection angle, and generating a secondary Bessel beam by forming an image of the primary Bessel beam in an image space, wherein the secondary Bessel beam provides the non-diffracting beam.

In another embodiment of the disclosed method, the secondary Bessel beam may have a focusing angle, and the method may further include controlling a depth of the perforations in the optical fiber by adjusting the focusing angle of the secondary Bessel beam.

In another embodiment of the disclosed method, the primary Bessel beam may be imaged by a telescope having a collector lens with a first focal length and an objective lens with a second focal length, and adjusting the focusing angle may include adjusting one or more of the first focal length of the collector lens, the second focal length of the objective lens, a beamwidth of the laser beam received by the axicon lens, and the deflection angle of the axicon lens.

In another embodiment of the disclosed method, adjusting the focusing angle may further include adjusting one or both of a first distance between the collector lens and the axicon lens, and a second distance between the objective lens and the collector lens.

In another embodiment of the disclosed method, the axicon lens may be part of an optical assembly including a telescope that forms the image of the primary Bessel beam in the image space, and scanning the non-diffracting beam across the optical fiber may include at least one of moving the optical assembly relative to the optical fiber and moving the optical fiber relative to the optical assembly.

In another embodiment of the disclosed method, scanning the non-diffracting beam across the optical fiber to define the perforation plane in the optical fiber may include pulsing the non-diffracting beam at a repetition rate, and laterally translating the optical fiber across the non-diffracting beam at a speed such that adjacent perforations of the plurality of perforations connect to form the perforation plane.

In another embodiment of the disclosed method, the optical fiber may include an optical axis, and the perforation plane may be oriented at an angle within a range of 0 to 10 degrees to a plane perpendicular to the optical axis of the optical fiber.

In another embodiment of the disclosed method, the optical fiber may be a hollow-core optical fiber.

In another embodiment of the disclosed method, the optical fiber may include one or more of a coating and a cladding, and the perforations may be formed through the one or more of the coating and the cladding.

In another embodiment of the disclosed method, the non-diffracting beam may have a wavelength between 500 nanometers and 1100 nanometers, a pulse width between 2 picoseconds and 15 picoseconds, and a repetition rate between 5 kilohertz and 1 megahertz.

In another aspect of the disclosure, an improved system for cleaving an optical fiber is disclosed. The system includes a laser configured to output a laser beam having a pulse width and a repetition rate, an optical assembly configured to receive the laser beam and output the non-diffracting beam, one or more translation stages configured to move at least one of the optical assembly relative to the optical fiber and the optical fiber relative to the optical assembly, and a computer operatively coupled to the laser and the one or more translation stages. The computer is configured to cause the laser to selectively output the laser beam having the pulse width and the repetition rate, and cause the one or more translation stages to scan the non-diffracting beam across the optical fiber such that the plurality of perforations are created in the optical fiber to define the perforation plane in the optical fiber.

In one embodiment of the disclosed system, the optical assembly may include the telescope having the object space and the image space, and the axicon lens that receives the laser beam and outputs a converging conical wavefront that defines the primary Bessel beam in the object space of the telescope. In this embodiment, the telescope may be configured to form the secondary Bessel beam in the image space that provides the non-diffracting beam.

In another embodiment of the disclosed system, the telescope may include the collector lens that faces the object space and has the first focal length, and the objective lens that faces the image space and has the second focal length.

In another embodiment of the disclosed system, the second focal length may be longer than the first focal length.

In another embodiment of the disclosed system, the collector lens may be spaced from the objective lens by the first distance equal to the sum of the first focal length and the second focal length, the collector lens may be spaced from the primary Bessel beam by the first focal length, and the secondary Bessel beam may be spaced from the objective lens by the second focal length.

In another embodiment of the disclosed system, the system may further include a goniometric stage configured to tilt the optical fiber along its optical axis so that the perforation plane is oriented at an angle within the range of 0 to 10 degrees to the plane perpendicular to the optical axis of the optical fiber.

In another embodiment of the disclosed system, the non-diffracting beam may have a wavelength between 500 nanometers and 1100 nanometers, the pulse width may be between 2 picoseconds and 15 picoseconds, and the repetition rate may be between 5 kilohertz and 1 megahertz.

In another embodiment of the disclosed system, the one or more translation stages may include a first translation stage that moves the optical assembly relative to a fixed reference frame, and a second translation stage that moves the optical fiber relative to the fixed reference frame.

In another embodiment of the disclosed system, the first translation stage may be a single-axis translation stage that moves the optical assembly longitudinally towards and away from the optical fiber, and the second translation stage may be a two-axis translation stage that moves the optical fiber laterally relative to the optical assembly.

The disclosed embodiments offer a cleaving process that produces cleaved fiber end faces having increased flatness and consistency (e.g., reduced roll-off, hackle, and chipping) as compared to mechanical cleaving. Adjustable laser parameters may be selected to reduce damage to the cladding, enable consistent cleaving of thick samples. Embodiments advantageously avoid the need to rotate the sample to minimize the chipping/hackle region, avoid the need for eccentricity control (e.g., by a rotation stage), provide high throughput and yield on hollow-core optical fibers using nano-perforations made through coatings in the production line to avoid contamination and handling issues, and enable field splicing without the need for field cleaving by preprocessing optical fibers to have pre-formed nano-perforations.

### BRIEF DESCRIPTION OF THE DRAWINGS

The accompanying drawings are included to provide a further understanding and are incorporated in and constitute a part of this specification. The drawings illustrate one or more embodiment(s), and together with the description serve to explain principles and operation of the various embodiments. Features and attributes associated with any of the embodiments shown or described may be applied to other embodiments shown, described, or appreciated based on this disclosure.

FIG. 1 is a cross-sectional view of an exemplary hollow-core optical fiber.

FIGS. 2A and 2B are micrographic views of the end faces of mechanically cleaved hollow-core optical fibers.

FIG. 3A is a schematic view of a system for creating nano-perforations in an optical fiber such as shown in FIGS. 1-2B and that includes an optical assembly having an axicon lens and an optical fiber translation stage that moves the optical fiber relative to the optical assembly.

FIG. 3B is a diagrammatic view of the axicon lens of FIG. 3A.

FIG. 4 is a perspective view of a system for operatively coupling the optical fiber to the optical fiber translation stage of FIG. 3A.

FIG. 5A is a cross-sectional view showing simulated Bessel beam intensity in a hollow-core optical fiber for a cleave angle of 0 degrees.

FIG. 5B is a cross-sectional view showing simulated locations of nonlinear absorption in the hollow-core optical fiber of FIG. 5A.

FIG. 6A is a side view of a hollow-core optical fiber showing nano-perforations created through the cladding of the hollow-core optical fiber by a Bessel beam.

FIG. 6B is a front view of the end face of the left side fiber tip of the hollow-core optical fiber of FIG. 6A after cleaving.

FIG. 6C is a side view of the left side fiber tip of the hollow-core optical fiber of FIG. 6A.

FIG. 6D is a front view of the end face of the right side fiber tip of the hollow-core optical fiber of FIG. 6A.

FIG. 6E is a side view of the right side fiber tip of the hollow-core optical fiber of FIG. 6A.

FIG. 7A is a side view of another hollow-core optical fiber including a coating that shows nano-perforations created through the coating by a Bessel beam.

FIG. 7B is a front view of an end face of the left side fiber tip of the hollow-core optical fiber of FIG. 7A.

FIG. 7C is a side view of the left side fiber tip of the hollow-core optical fiber of FIG. 7A.

FIG. 7D is a front view of an end face of the right side fiber tip of the hollow-core optical fiber of FIG. 7A.

FIG. 7E is a side view of the right side fiber tip of the hollow-core optical fiber of FIG. 7A.

FIG. 8A is a side view of an anti-resonant hollow-core optical fiber including a coating that shows nano-perforations created through the coating by a Bessel beam.

FIG. 8B is a front view of an end face of the hollow-core optical fiber of FIG. 8A.

FIG. 8C is a side view of the hollow-core optical fiber of FIG. 8A.

FIGS. 9A and 9B are diagrammatic views of a user interface of a fusion splicer showing an anti-resonant hollow-core optical fiber cleaved after nano-perforations were created in the optical fiber by a Bessel beam.

FIG. 10 is micrographic side view of the anti-resonant hollow-core optical fibers of FIGS. 9A and 9B after being spliced together.

FIG. 11A is a cross-sectional view showing simulated Bessel beam intensity in a hollow-core optical fiber for a cleave angle of 3 degrees.

FIG. 11B is a cross-sectional view showing simulated Bessel beam intensity in a hollow-core optical fiber for a cleave angle of 5 degrees.

FIG. 11C is a cross-sectional view showing simulated Bessel beam intensity in a hollow-core optical fiber for a cleave angle of 10 degrees.

FIG. 11D is a cross-sectional view showing simulated locations of nonlinear absorption in the hollow-core optical fiber for the cleave angle of 3 degrees.

FIG. 11E is a cross-sectional view showing simulated locations of nonlinear absorption in the hollow-core optical fiber for the cleave angle of 5 degrees.

FIG. 11F is a cross-sectional view showing simulated locations of nonlinear absorption in the hollow-core optical fiber for the cleave angle of 10 degrees.

FIGS. 12A and 12B are diagrammatic views of a user interface of a fusion splicer showing an anti-resonant hollow-core optical fiber with a cleave angle of about 3 degrees.

FIG. 13 is a graphical view including plots of measured angle versus designed angle for a plurality of hollow-core optical fibers laser cleaved through the cladding.

FIG. 14 is a diagrammatic view showing hollow-core optical fibers cleaved in the same configuration (e.g., at the same angle) being connected by aligning the end face angle and the hollow-core pattern.

FIG. 15 is a diagrammatic view showing cleaved hollow-core optical fibers with polished thin end caps connected by physical contact.

FIGS. 16A and 16B are diagrammatic views showing an angled cleaved hollow-core optical fiber spliced to an angled solid-core optical fiber.

FIG. 17 is a diagrammatic view showing a 3 degree angled interface refractive index profile between a hollow-core optical fiber and a solid-core optical fiber.

FIG. 18 is a side view showing beam propagation in a segment of the interface of FIG. 17.

FIG. 19A is a cross-sectional view showing simulated Bessel beam intensity in a hollow-core optical fiber for a Bessel beam having a focusing angle of 6 degrees.

FIG. 19B is a cross-sectional view showing areas where the simulated Bessel beam intensity is sufficient to cause nonlinear absorption of the beam in the hollow-core optical fiber of FIG. 19A.

FIG. 20A is a cross-sectional view showing simulated Bessel beam intensity in a hollow-core optical fiber for a Bessel beam having a focusing angle of 12 degrees.

FIG. 20B is a cross-sectional view showing areas where the simulated Bessel beam intensity is sufficient to cause nonlinear absorption of the beam in the hollow-core optical fiber of FIG. 20A.

FIG. 21A is a cross-sectional view showing simulated Bessel beam intensity in a hollow-core optical fiber for a Bessel beam having a focusing angle of 18 degrees.

FIG. 21B is a cross-sectional view showing areas where the simulated Bessel beam intensity is sufficient to cause nonlinear absorption of the beam in the hollow-core optical fiber of FIG. 21A.

FIG. 22A is a cross-sectional view showing simulated Bessel beam intensity in a hollow-core optical fiber for a Bessel beam having a focusing angle of 24 degrees.

FIG. 22B is a cross-sectional view showing areas where the simulated Bessel beam intensity is sufficient to cause nonlinear absorption of the beam in the hollow-core optical fiber of FIG. 22A.

FIG. 23A is a cross-sectional view showing simulated Bessel beam intensity in a hollow-core optical fiber for a Bessel beam having a focusing angle of 30 degrees.

FIG. 23B is a cross-sectional view showing areas where the simulated Bessel beam intensity is sufficient to cause nonlinear absorption of the beam in the hollow-core optical fiber of FIG. 23A.

FIG. 24A is a cross-sectional view showing simulated Bessel beam intensity in a hollow-core optical fiber for a Bessel beam having a focusing angle of 36 degrees.

FIG. 24B is a cross-sectional view showing areas where the simulated Bessel beam intensity is sufficient to cause nonlinear absorption of the beam in the hollow-core optical fiber of FIG. 24A.

FIG. 25A is a graphical view showing the fraction of the cladding region experiencing nonlinear absorption for simulations having different combinations of cleave angle θ_{cleave} and focusing angle θ_{f}.

FIG. 25B is a graphical view showing the fraction of the core region experiencing nonlinear absorption for simulations having different combinations of cleave angle θ_{cleave} and focusing angle θ_{f}.

FIG. 26 is a diagrammatic view of a user interface of a structure analysis tool that may be used for geometry measurement of laser cleaved hollow-core optical fibers.

FIG. 27 is a diagrammatic view of a computer that may be used to implement one or more of the systems or methods described herein.

It should be understood that the appended drawings are not necessarily to scale and may present a somewhat simplified representation of various features illustrative of the basic principles of the disclosure. For example, certain features illustrated by the drawings may be enlarged or distorted relative to others to facilitate visualization and a clear understanding.

### DETAILED DESCRIPTION

Various embodiments will be further clarified by examples in the description below. In general, the description relates to systems and methods for laser cleaving optical fibers, such as large diameter and specialty optical fibers, and in particular, hollow-core optical fibers. The improved quality of the cleaved fiber end faces produced by the disclosed laser cleaving may facilitate coupling of hollow-core optical fibers, for example, to both solid-core optical fibers (e.g., a standard single mode optical fiber) and to other hollow-core optical fibers.

The disclosed nano-perforation technique for cleaving optical fibers produces a cleaved fiber end face having a consistent angle and quality. Specifically, consistent cleaving is achieved with minimum roll-off, hackle, or chipping regions, which facilitates the splicing process. Nano-perforation is applied to the surfaces of optical fibers with a single directional relative motion, and then a mechanical force (e.g., air jet, tension, or bending) is applied to separate the optical fiber after nano-perforation. This process may avoid the need to strip or otherwise remove any coatings or cladding from the optical fiber prior to cleaving. This provides several unique advantages such as preventing excess damage to the cladding of the fiber, avoiding contamination of the fiber surface before splicing, making the optical fiber easier to handle, and so on.

In an embodiment of the disclosure, hollow-core optical fibers are cleaved by applying a non-diffracting beam (e.g., a Bessel beam) to the outer surface of the optical fiber, which creates nano-perforations in the optical fiber. The cleaves may be perpendicular or angled. The distance the non-diffracting beam penetrates into the optical fiber may be controlled by adjusting a focusing angle θ_{f} of the non-diffracting beam. The ability to control penetration depth may enable the prevention of damage caused by the nano-perforations from reaching the core region of the optical fiber. That is, precise control of penetration depth may enable nano-perforations to be created in the cladding, but not in the core region of the optical fiber. This penetration control feature may be particularly advantageous with hollow-core optical fibers, since damage to the core region caused by cleaving is generally impossible to remedy in these types of optical fibers. After nano-perforation to the cladding, the optical fiber may be separated using mechanical force. The cleaving angle θ_{cleave} may be selected by tilting the beam relative to the optical fiber so that the nano-perforations penetrate the optical fiber at the cleaving angle θ_{cleave}.

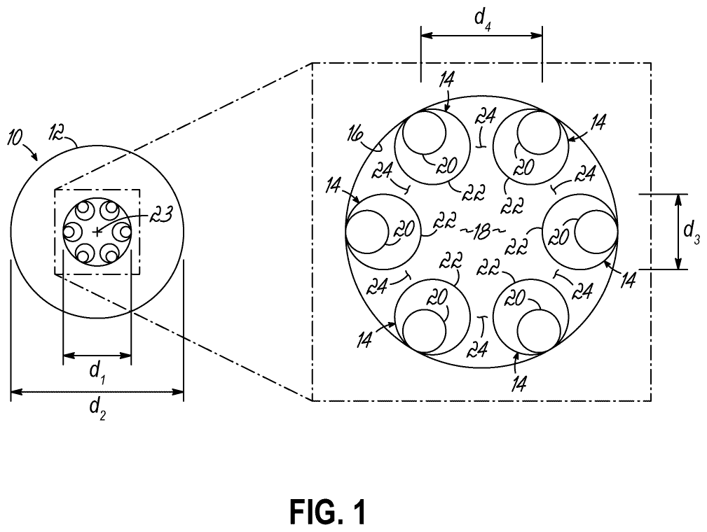

FIG. 1 depicts a cross-sectional axial view of an exemplary hollow-core optical fiber 10, e.g., a nested anti-resonant nodeless hollow-core optical fiber. The exemplary hollow-core optical fiber 10 includes a cladding 12 and a plurality of structural tubes 14 (or capillaries) arranged circumferentially on an inner surface 16 of the cladding 12 to define a hollow-core 18. The region of the hollow-core optical fiber 10 defined by the inner surface 16 of cladding 12 that includes the structural tubes 14 and hollow-core 18 may be referred to as the core region. More generally, or in the case of a solid-core optical fiber, the core region of the optical fiber may be considered as a region surrounding an optical axis thereof within a radius such that the region contains a relatively large portion of (or essentially all of) the total energy of the optical beam propagating through the optical fiber. For example, a region containing at least 86.5% of the total energy of the optical beam may constitute the core region. The depicted hollow-core optical fiber 10 includes six structural tubes 14 each having a nested structure comprising an inner tube 20 and an outer tube 22. It should be understood, however, that the fiber optic coupling systems and methods disclosed herein may be used with any type of hollow-core or solid-core optical fiber, and are therefore not limited to hollow-core optical fibers, much less anti-resonant hollow-core optical fibers including any specific number of structural tubes or structural tubes that are nested.

The cladding 12 and structural tubes 14 may be formed, for example, of doped or undoped silica glass. The cladding 12 may have an inner diameter d₁ and an outer diameter d₂, and the structural tubes 14 may have an outer diameter d₃. The dimensions of the cladding 12 and structural tubes 14 may be selected so that the hollow-core 18 has a diameter d₄ equal to twice the radius thereof. The radius of the hollow-core 18 may be defined, for example, as the minimum distance between the surfaces of structural tubes 14 and an optical axis 23 of the hollow-core optical fiber 10. The dimensions may also be selected so that adjacent structural tubes 14 are separated by a gap 24. The gap 24 may prevent adjacent structural tubes 14 from contacting each other. The gap 24 may thereby avoid the formation of a waveguide along a line of contact between the structural tubes 14 due to a doubling of the wall thickness of the structural tubes 14 where they come into contact.

The dimensions and other characteristics of the cladding 12 and structural tubes 14 (e.g., the refractive index) may be selected to define a waveguide that generally confines optical beams propagating through the hollow-core optical fiber 10 to the hollow-core 18. The thickness of the walls of the structural tubes 14 may also be selected to provide an anti-resonant effect that reduces leakage of optical beams from the hollow-core 18 into the structural tubes 14. This anti-resonant effect may be optimized by providing the structural tubes 14 with a wall thickness that is an odd multiple of a quarter wavelength of the optical beam. In an exemplary embodiment of the depicted hollow-core optical fiber 10, d₁ may be about 100 μm, d₂ may be about 250 μm, d₃ may be about 30 μm, and d₄ may be about 40 μm. In a further exemplary embodiment of a hollow-core optical fiber 10, d₁ may be about 100 μm, d₂ may be about 230 μm, and d₃ may be about 27 μm. Further, a diameter of the inner tube 20 may be about 14 μm, a thickness of the inner tube 20 and the outer tube 22 may be about 1.2 μm, and the gap 24 may be about 5 μm. However, as noted above, the fiber optic coupling systems and methods disclosed herein are not limited to hollow-core optical fibers having any particular set of structural dimensions.

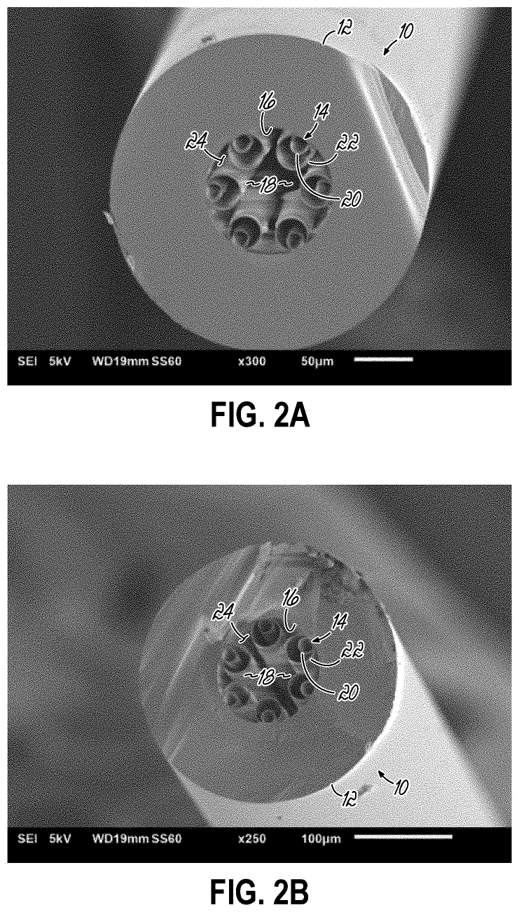

FIGS. 2A and 2B depict images showing samples of mechanically cleaved hollow-core optical fibers 10. The conventional way of cleaving optical fiber is by using mechanical fiber cleaving tools. The cleaving process consists essentially of two steps. The first step is to use the blade of a cleaver to damage the cladding of the optical fiber. The second step is to apply tension to the optical fiber to separate the optical fiber at the damaged point. The applied tension depends on the glass material and optical fiber diameter. Optical fibers with large diameters (e.g., beyond 200 μm) may be difficult to cleave mechanically. The samples depicted by FIGS. 2A and 2B were cleaved with a Fujikura mechanical cleaver. As can be seen, the samples have chip or lip defects on their cleaved fiber end faces. These defects (and other damage that can be caused by mechanical cleaving) could impact the performance of hollow-core optical fibers 10. For example, scanning electron microscopy analysis, free-spacing loss/beam profile measurement, splicing for connectivity, and other processes may be negatively impacted.

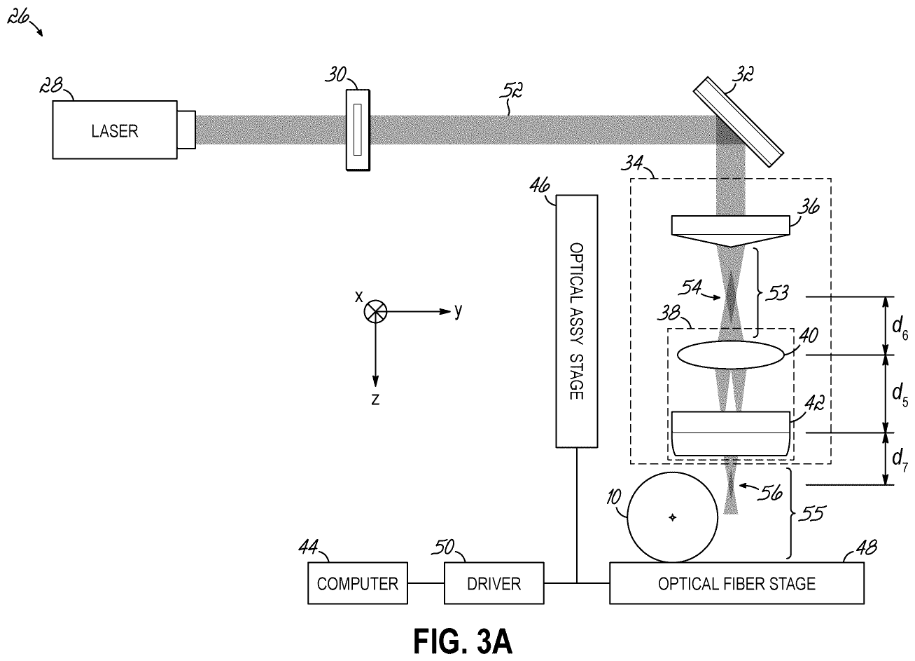

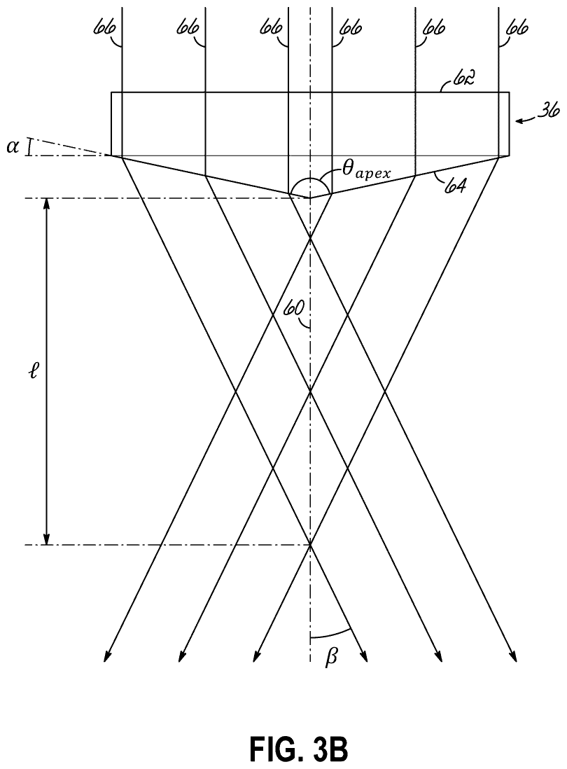

FIG. 3A depicts an exemplary system 26 that may be used to perform a laser cleaving process using a laser. Using a laser to create nano-perforations may be advantageous in comparison with traditional tools in that use of the laser avoids the above described damage which may be caused by mechanical cleaving. The system 26 of FIG. 3A may utilize what is referred to herein as nano-perforation cutting. Nano-perforation cutting is a technique that uses a non-diffracting beam (e.g., a Bessel beam) formed from laser pulses to cut glass substrates. A non-diffracting beam is a type of laser beam having an elongated focal region. Typical dimensions for the elongated focal region may be a width on the order of one to ten microns and a length on the order of hundreds or thousands of microns. Bessel beams may have a focal region that is relatively long (e.g., l>1 mm) and narrow (d=0.5-5 μm). These dimensions may allow the Bessel beam to create a perforation through the entire thickness of a glass sample with a single laser pulse. In nano-perforation cutting, the non-diffracting beam may be formed from light having a wavelength λ at which the glass substrate is normally transparent, e.g., λ=512 nm, 515 nm, 1030 nm, or 1064 nm. The beam can therefore pass through the glass unhindered under normal conditions. However, a phenomenon known as nonlinear absorption may result in energy being absorbed in regions of the glass where the beam has a sufficiently high intensity, such as the focal region of a Bessel beam.

In the case of optical fiber cleaving, the non-diffracting beam may be directed into the optical fiber from the side, resulting in a perforation being created in the sample thickness by the laser damaging the glass. By scanning the non-diffracting beam across the optical fiber while the laser beam is pulsed, a series of perforations may be created through the glass of the optical fiber. Thus, a pulsed laser may be used in combination with lateral translation of the optical fiber across the path of the non-diffracting beam to create a series of nano-perforations through the optical fiber. If the scan speed and the pulse repetition rate of the laser are controlled such that the distance traveled between pulses in the optical fiber (or “pitch”) is sufficiently short (e.g., 0.1 to 50 μm), then the perforations may form a planar perforated region (or “perforation plane”) in the optical fiber. For example, the pitch may be short enough so that damage surrounding the perforations connects adjacent perforations.

The perforation plane may provide a weakened planar region through a cross section of the optical fiber. When a force is subsequently applied to the optical fiber (such as a puff of air, axial tension, or lateral bending), the optical fiber may break along the perforation plane. The perforated optical fiber typically breaks cleanly along the perforation plane even if the perforation plane only covers a portion of the total cross-sectional area of the optical fiber. An advantageous feature of this technique is that the core region of the optical fiber may remain undamaged and have a flat, smooth plane, which may facilitate forming a good splice with another optical fiber. Two conditions that contribute to this result may be met by configuring the non-diffracting beam to avoid damaging the core region of the optical fiber while also causing sufficient damage to the cladding to ensure the break is flat across the core region.

Accordingly, the system 26 may be configured to create nano-perforations in an optical fiber, e.g., a hollow-core optical fiber 10. To this end, the system 26 may include a laser 28 (e.g., an ultrafast laser), a shutter 30, a mirror 32, and a Bessel beam optical assembly 34. The Bessel beam optical assembly 34 may include an axicon lens 36 and a telescope 38 having a collector lens 40 and an objective lens 42. The system 26 may be controlled by a computer 44 operatively coupled to an optical assembly translation stage 46 (e.g., a z-axis stage) and an optical fiber translation stage 48 (e.g., an x-y axis stage) through a driver 50 configured to drive the stages 46, 48 in response to signals received from the computer 44.

The optical fiber translation stage 48 may comprise a two-axis translation stage configured to receive an optical fiber 10 and to move the optical fiber 10 along two or more different axes (e.g., the x and the y-axes) relative to a fixed reference frame, e.g., an optical table (not shown). The optical assembly translation stage 46 may comprise a single-axis translation stage operatively coupled to, and configured to move, the Bessel beam optical assembly 34 along another axis different from the axes of optical fiber translation stage 48 (e.g., the z-axis) relative to the fixed reference frame. The translation stages 46, 48 may thereby enable the computer 40 to selectively position the optical fiber 10 in three-dimensions relative to the Bessel beam optical assembly 34.

The laser 28 may be an ultrafast laser, such as a PHAROS Light Conversion laser that can be obtained from LIGHT CONVERSION-USA, INC, of Bozeman, Montana, United States. The laser 28 may be configured to output, for example, a pulsed laser beam 52 having a selectable central wavelength (e.g., λ=1030 nm) pulse width (e.g., tₚᵤₗₛₑ=10 ps) and repetition rate (e.g., fᵣₑₚ=50 kHz). The maximum output power Pmax of the laser may be about 8 W. However, the output power may be adjusted during processing by decreasing the repetition rate of the laser, e.g., fᵣₑₚ<50 KHz.

Referring now to FIG. 3B, and with continued reference to FIG. 3A, the laser beam 52 may be reflected by the mirror 32 so that the laser beam 52 is received by the axicon lens 36. The axicon lens 36 may include an optical axis 60, a planar surface 62, and a conical surface 64 opposite the planar surface 62. The axicon lens 36 may be made from an optical material (e.g., silica glass) having an index of refraction n₁ greater than the index of refraction n₂ of the surrounding medium (e.g., air). The conical surface 64 may have an axicon angle α relative to planar surface 62 and an apex angle θₐₚₑₓ=(180°−2×α). Rays 66 of the laser beam 52 incident on the conical surface 64 may be refracted by a deflection angle β in accordance with Snell's law, which results in a deflection angle β given by:

$$β = {sin}^{- 1} ( \frac{{n}_{1}}{{n}_{2}} sin ( α ) ) - α \qquad ( Eqn . 1 )$$

The conical surface 64 may bend the rays 66 of laser beam 52 at the deflection angle β so that the rays 66 converge, thereby forming a conical wavefront. The rays 66 of this conical wavefront may interfere constructively along the optical axis 60 to define an elongated focal region. The light in the focal region may have a quasi-Bessel structure that forms a primary Bessel beam 54 having length l. The length l may also be referred to as a depth of focus of the primary Bessel beam 54.

The telescope 38 may be a demagnifying telescope having a 4F configuration with an object space 53 on the axicon side of the collector lens 40 and an image space 55 on the fiber side of the objective lens 42. The collector lens 40 may be a converging lens (e.g., a plano-convex, bi-convex, or meniscus lens) having a focal length f₁, and the objective lens 42 may be a converging lens (e.g., a plano-convex, bi-convex, or meniscus lens) having a focal length f₂. The collector lens 40 and objective lens 42 may be spaced from one another along the optical path of laser beam 52 by a distance d₅≈f₁+f₂. The collector lens 40 may be spaced from the primary Bessel beam 54 (e.g., from a midpoint thereof) by a distance d₆≈f₁ such that the Bessel beam 54 is in the object space 53 of telescope 38.

The collector lens 40 may receive the laser beam 52 and transmit the laser beam 52 to the objective lens 42. The objective lens 42 may further focus the laser beam 52 received from the collector lens 40 to form a secondary Bessel beam 56 in the image space 55 of telescope 38, e.g., at a distance d₇≈f₂ from the objective lens 42. Thus, the secondary Bessel beam 56 may be an image (e.g., a demagnified image) of the primary Bessel beam 54 formed in the image space 55 of telescope 38.

The telescope 38 may be configured to demagnify the primary Bessel beam 54 and increase the focusing angle θ_{f} of the converging conical wavefront. The amount of demagnification M may be set by selection of the focal lengths of the lenses 40, 42, where:

$$M = \frac{{f}_{2}}{{f}_{1}} \qquad ( Eqn . 2 )$$

The focusing angle θ_{f} and length of the secondary Bessel beam 56 may be controlled by changing the ratio of the focal lengths f₁, f₂ of the collector and objective lenses 40, 42, and may also depend on the diameter of the laser beam 52 received by the axicon lens 36 and the cone angle θ_{c} of the axicon lens 36. Accordingly, the full width at half maximum (FWHM) of the secondary Bessel beam 56 in the optical fiber 10 may be provided by:

$$FWHM = \frac{M {w}_{0} n}{sin ( {θ}_{f} )} \qquad ( Eqn . 3 )$$

where w₀ is the beamwidth of the (Gaussian) laser beam 52 received by the axicon lens 36 and n is the index of refraction of the optical fiber 10. The magnitude of the focusing angle θ_{f} may depend on the optical system, and can be calculated as:

$${θ}_{f} = {sin}^{- 1} ( M \times sin ( {θ}_{c} ) ) \qquad ( Eqn . 4 )$$

The full width at half maximum value may be chosen so that the secondary Bessel beam 56 is sufficiently long to perforate the optical fiber 10 (accounting for imprecision in fiber position), but short enough so that the secondary Bessel beam 56 has sufficient energy to stimulate nonlinear absorption in the optical fiber 10. Typical secondary Bessel beam lengths/may range from 0.5 to 2 mm. The collector and objective lenses 40, 42 may facilitate tuning the full width at half maximum value independently of focusing angle θ_{f} in accordance with Equations 2-4. This may enable optimization of the full width at half maximum value for any focusing angle θ_{f}.

The laser beam 52 may be switched on and off through use of the shutter 30 to control exposure. As described above, the laser beam 52 from the laser 28 may be formed into the secondary Bessel beam 56 by the combination of the axicon lens 36, the collector lens 40, and the objective lens 42. The laser beam 52 may thereby be focused inside the hollow-core optical fiber 10 by the Bessel beam optical assembly 34. In one embodiment, the secondary Bessel beam 56 may have a spot size of about 1 μm and a depth of focus of about 1 mm, which can fully span the diameter of the optical fiber 10.

The hollow-core optical fiber 10 may be operatively coupled (e.g., clamped) to the optical fiber translation stage 48 using a commercial fiber holder such as an FH-100-250 commercially available from Fujikura Ltd. of Tokyo, Japan. The commercial fiber holder may be mounted on the optical fiber translation stage 48, which may be configured to move in the x and y-directions. The optical fiber translation stage 48 may be a high-precision computer controlled two-axial (e.g., x and y-axis) translation stage with a resolution of 0.01 μm, such as a PRO225 translation stage (commercially available from Aerotech, Inc. of Pittsburgh, Pennsylvania, United States), or any other suitable translation stage. Additionally, the Bessel beam optical assembly 34 may be mounted on the optical assembly translation stage 46, which may be configured to move in a direction orthogonal to the two axes of the optical fiber translation stage 48, e.g., the z-direction. The optical assembly translation stage 46 may be a PRO165 stage, which is also commercially available from Aerotech, Inc., or any other suitable translation stage. Both translation stages 46, 48 may be driven by the driver 50 and controlled by the computer 48.

In an exemplary embodiment, the velocity of the translation stage 48 may be set to a value that provides an appropriate pitch during fabrication, e.g., 20 mm/s. To obtain an appropriate pitch between two adjacent perforation holes in the hollow-core optical fiber 10, the internal pulse divider of the laser 28 may be set to a repetition rate of about 4166 Hz. As a result of this exemplary velocity and repetition rate, the pitch may be roughly calculated to be 4.8 μm. The pitch may be varied by changing the repetition rate of the laser 28, a pulse divider of the pulse picker, and/or the velocity of the translation stage 48. After the nano-perforation process, the hollow-core optical fiber 10 may be separated by applying tension (e.g., by mechanical means) along its optical axis 23. It is also contemplated that liquid-assisted laser cleaving may be used for both flat and angled cleaves. It is further contemplated that dual-Bessel beam cleaving may also be used, e.g., if the cladding diameter is greater than 800 μm.

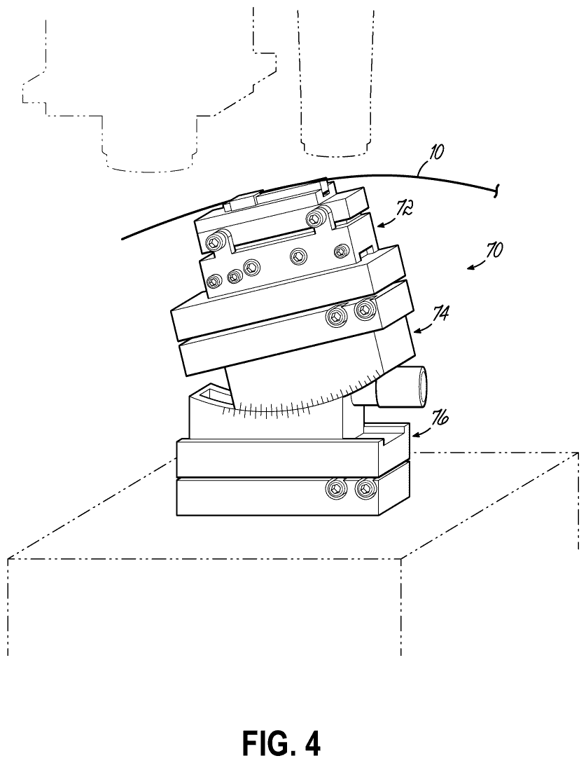

FIG. 4 depicts an exemplary angled-cleave station 70, which may be operatively coupled to the optical fiber translation stage 48. The angled-cleave station 70 may include a compact 5-axis pitch, yaw, and translation stage 72, a goniometric stage 74, and kinematic plates 76. For cleaving at a distal angle of zero degrees (e.g., so that the end face of the optical fiber is perpendicular to the optical axis), the goniometric stage 74 may be set to 0 degrees. For cleaving at a distal angle other than 0 degrees (e.g., 3 degrees, 5 degrees, or 8 degrees), the goniometric stage 74 may be adjusted to the desired angle. However, it should be understood that the angle set on the goniometric stage 74 may differ from the achieved cleave angle to compensate for Snell's law of refraction. For example, the goniometric stage 54 may be set to about 11.5 degrees to obtain an 8 degree cleave angle in the optical fiber. Exemplary relationships between the designed cleave angle and present angle setting of the goniometric stage are shown below.

TABLE I
RELATIONSHIP BETWEEN DESIGNED
ANGLE & PRESET ANGLE

| Hollow-core fiber angled end face (degrees) | Incident angle (degrees) |
|---|---|
| 1 | 1.45008 |
| 2 | 2.90065 |
| 3 | 4.3522 |
| 4 | 5.80522 |
| 5 | 7.26021 |
| 6 | 8.71771 |
| 7 | 10.1782 |
| 8 | 11.6423 |

When an optical beam enters a material, it may be refracted according to the material's index of refraction. In the case of an optical fiber, refraction across the curved outer surface of the cladding may cause aberrations in the secondary Bessel beam 56. These aberrations may reduce the peak intensity of the secondary Bessel beam 56, and may also increase in magnitude as the secondary Bessel beam 56 penetrates deeper into the optical fiber 10. These effects may limit the cutting depth of the secondary Bessel beam 56. The presence of certain aberrations may be used to protect the core region by limiting the depth of nano-perforation damage to less than half the thickness of the optical fiber 10. However, excessive aberrations can also reduce the effectiveness of the nano-perforation process such that the optical fiber 10 does not consistently cleave at the perforation plane. The strength of the aberrations may also increase in cases where the cleave angle is greater than zero. Thus, aberrations may limit the maximum cutting angle of the nano-perforation process if not controlled.

Advantageously, the strength of the aberrations can be controlled by altering the focusing angle θ_{f} of the secondary Bessel beam 56. For example, the focusing angle θ_{f} may be reduced to control aberrations when cleaving an anti-resonant hollow-core optical fiber 10 at a high cleaving angle θ_{cleave}. The reduced focusing angle θ_{f} may reduce the aberrations in the secondary Bessel beam 56, thereby increasing penetration and enabling consistent cutting. Conversely, the focusing angle θ_{f} may be increased when cleaving an anti-resonant hollow-core optical fiber 10 at a low cleaving angle θ_{cleave} to protect the core region from being damaged by the nano-perforation process. Advantageously, controlling the strength of aberrations in the secondary Bessel beam 56 by adjusting the focusing angle θ_{f} may enable control of the penetration depth of the secondary Bessel beam 56 into the optical fiber 10. Increased penetration depth (by decreasing the focusing angle θ_{f}) may improve cleaving consistency and allow optical fibers to be cleaved with larger cleaving angles. Reduced penetration depth (by increasing the focusing angle θ_{f}) may protect the core region of the optical fiber 10 during the nano-perforation process. An optimum focusing angle θ_{f} may be selected for each type of optical fiber and cleaving angle, for example, by altering the configuration of the Bessel beam optical assembly 34.

The strength of the aberrations may also be adjusted based on the numerical aperture NA of the secondary Bessel beam 56. Numerical aperture is a theoretical parameter that may be used to characterize an optical system or beam, and is a measure of the ability of the optical system or beam to accept or provide light. The numerical aperture of the secondary Bessel beam 56 may be related to the focusing angle θ_{f} by the equation:

$$NA = n \times sin ( {θ}_{f} ) \qquad ( Eqn . 5 )$$

where n is the index of refraction of the medium through which the beam is passing, e.g., n=1.00 for air or 1.45 for silica. Accordingly, either numerical aperture or focusing angle θ_{f} may be used as a metric to predict or control penetration of the secondary Bessel beam 56 into an optical fiber.

FIGS. 5A and 5B depict simulated secondary Bessel beams 56 as they propagate into and through a computer model of an exemplary hollow-core optical fiber 10 (FIG. 5A), and simulated locations of nonlinear absorption 80 of the secondary Bessel beams 56 in the hollow-core optical fiber 10 (FIG. 5B) for a cleave angle of 0 degrees. The figures show fiber location with a dark gray background for air and lighter gray circular area for glass. Refraction may cause the secondary Bessel beams 56 to bend as they enter the hollow-core optical fiber 10. Note that refraction may also cause reduced intensity within the hollow-core optical fiber 10, which may prevent some portions of each secondary Bessel beam 56 from damaging the hollow-core optical fiber 10. The secondary Bessel beam 56 may bend due to refraction as it enters the hollow-core optical fiber 10, resulting in aberrations in the secondary Bessel beam 56 that increase as the secondary Bessel beam 56 propagates deeper into the hollow-core optical fiber 10. These aberrations may reduce the intensity of the secondary Bessel beam 56 until it falls below the threshold for nonlinear absorption and ceases to perforate the hollow-core optical fiber 10. The intensity of the aberrations may be dependent on one or more of the focusing angle θ_{f} of the secondary Bessel beam 56, the index of refraction of the hollow-core optical fiber 10, the maximum radius of the hollow-core optical fiber 10 being perforated, the angle at which the hollow-core optical fiber 10 is being cut, and the relative position between the secondary Bessel beam 56 and the hollow-core optical fiber 10.

The secondary Bessel beam 56 was simulated using the wave propagation method (WPM), which is a modification of the common pulse propagation and angular spectrum methods. In the wave propagation method, laser beams are simulated as a complex electrical field that is propagated according to a fast Fourier transform (FFT) solution of the Raleigh-Somerfield diffraction integral. The simulated field u may be given by:

$$u = {u}_{0} {e}^{ikr sin {θ}_{f}} \qquad ( Eqn . 6 )$$

where u₀ is the transverse intensity profile of the (Gaussian) input laser beam 52, k is the wavenumber of the input laser beam 52, and r is the distance from the center of the optical axis. The transverse intensity profile u₀ may be given by:

$${u}_{0} = {e}^{{r}^{2 / {( \frac{{w}_{0}}{2} )}^{2}}} \qquad ( Eqn . 7 )$$

where w₀ is the diameter of the secondary Bessel beam 56 after demagnification by the collector and objective lenses 40, 42. The distance r may be obtained as:

$$r = \sqrt{{x}^{2} + {y}^{2}} \qquad ( Eqn . 8 )$$

With continued reference to FIGS. 5A and 5B, the model of the hollow-core optical fiber 10 was placed so that the peak intensity of the simulated secondary Bessel beam 56 was inside the fiber, and the secondary Bessel beam 56 was propagated through the hollow-core optical fiber 10. The hollow-core optical fiber 10 was then translated laterally by 20 μm and the simulation repeated until the secondary Bessel beam 56 no longer passed through the hollow-core optical fiber 10. Simulations used a larger pitch than was used for experimental nano-perforation of hollow core optical fibers to reduce simulation time due to the high resolution requirements of the wave propagation method.

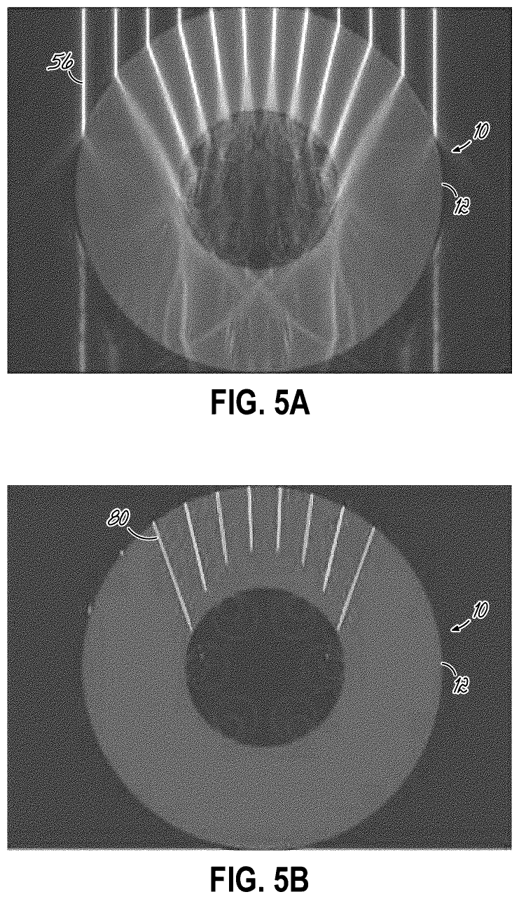

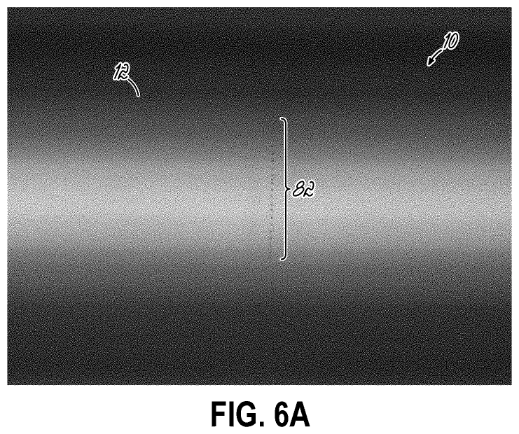

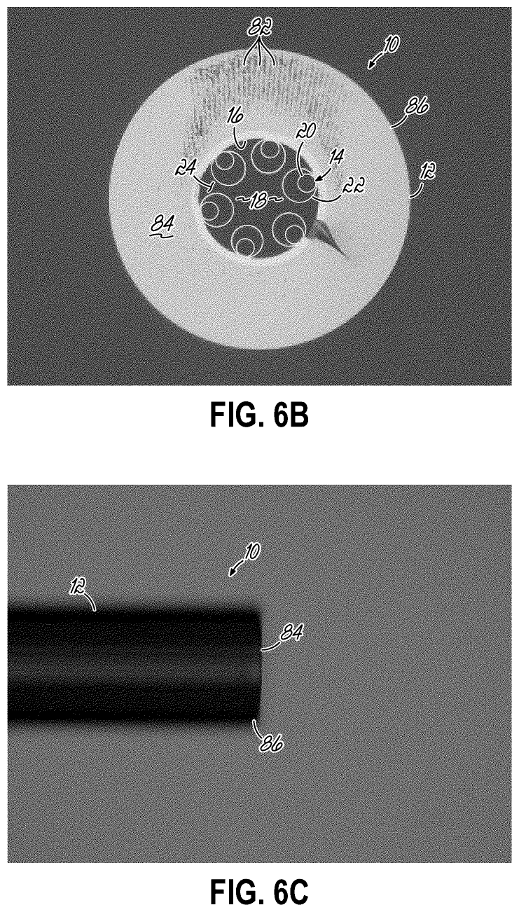

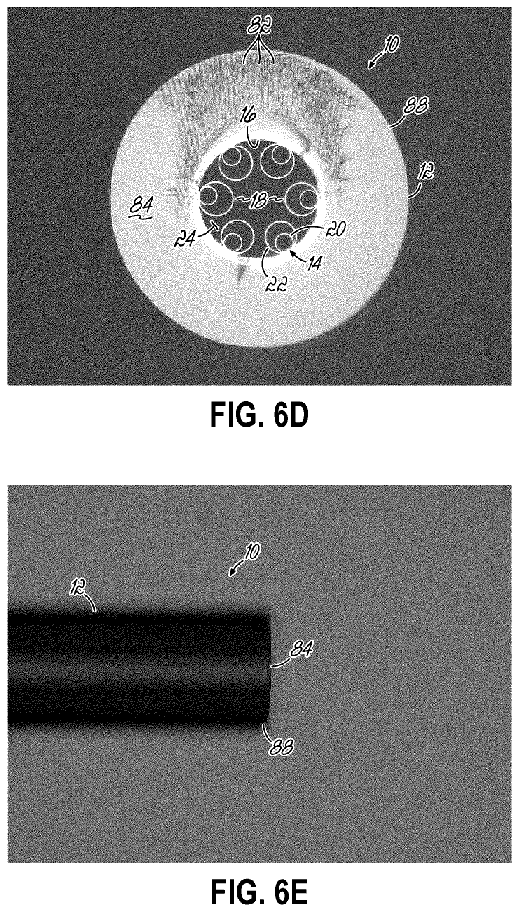

FIGS. 6A-6E depict an exemplary hollow-core optical fiber 10 that has been cleaved with a Bessel beam through the cladding 12 thereof. The hollow-core optical fiber 10 was separated by hand after cleaving at the cut point. FIG. 6A shows nano-perforations 82 in the cladding 12 of the hollow-core optical fiber 10 prior to separation of the hollow-core optical fiber 10 along the nano-perforations 82. FIG. 6B shows the cleaved fiber end face 84 of the left side fiber tip 86. FIG. 6C is a side view of the left side fiber tip 86. FIG. 6D shows the cleaved fiber end face 84 of the right side fiber tip 88. FIG. 6E is a side view of the right side fiber tip 88. As shown, Bessel beam cleaving offers high cleaving quality for hollow-core optical fibers 10, even as applied through the cladding 12 thereof. For example, a rough area of the cleaved fiber end face 84 may have a surface roughness between approximately 0.1 micrometers and approximately 2 micrometers root mean square. Additionally, an area outside of the rough area may have a surface roughness of less than approximately 10 nanometers root mean square.

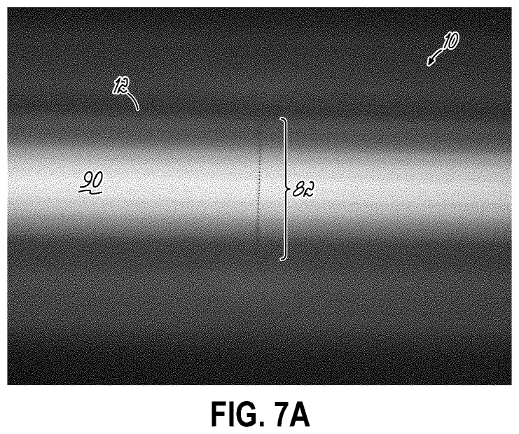

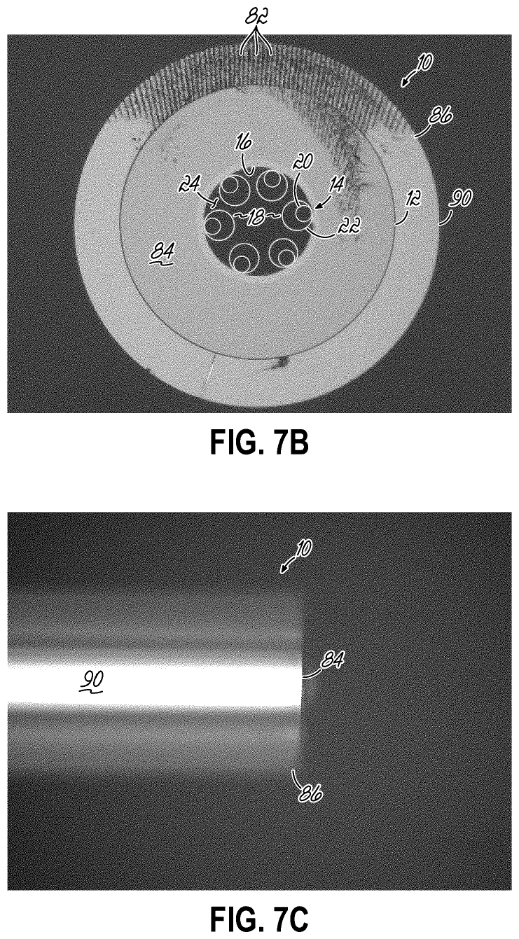

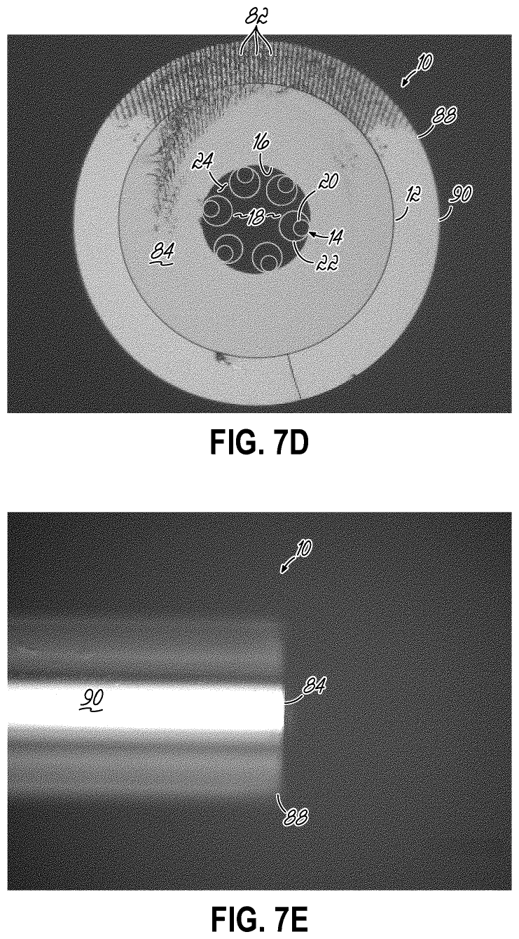

FIGS. 7A-7E depict an exemplary hollow-core optical fiber 10 that has been cleaved with a Bessel beam through a coating 90 on the hollow-core optical fiber 10. The hollow-core optical fiber 10 was separated by hand after cleaving at the cut point. FIG. 7A shows nano-perforations 82 in the coating 90 on the hollow-core optical fiber 10 prior to separation of the hollow-core optical fiber 10 along the nano-perforations 82. FIG. 7B shows the cleaved fiber end face 84 of the left side fiber tip 86. FIG. 7C is a side view of the left side fiber tip 86. FIG. 7D shows the cleaved fiber end face 84 of the right side fiber tip 88. FIG. 7E is a side view of the right side fiber tip 88. As shown, Bessel beam cleaving offers high cleaving quality for hollow-core optical fibers 10, even as applied through the coating 90 on the hollow-core optical fibers 10.

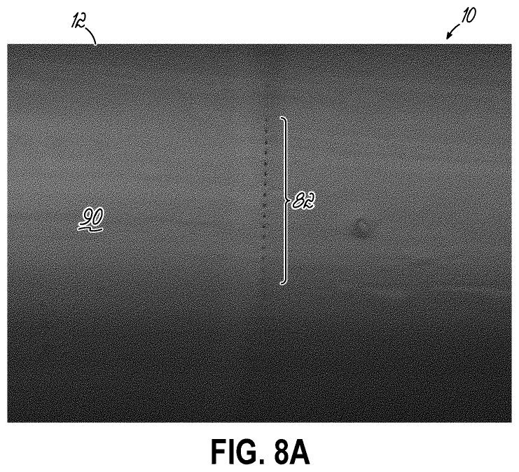

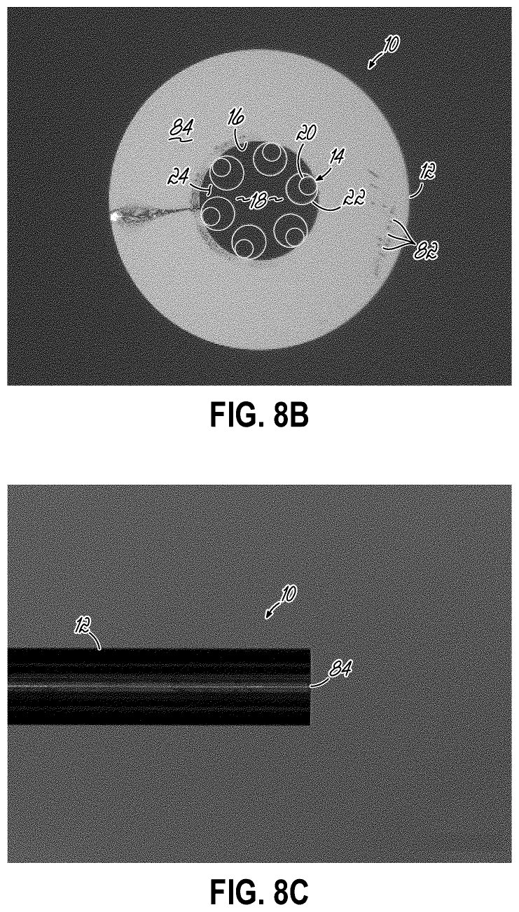

FIGS. 8A-8C depict an anti-resonant hollow-core optical fiber 10 that has been cleaved with a Bessel beam through a coating 90 on the hollow-core optical fiber 10. The hollow-core optical fiber 10 was window-stripped and separated mechanically (e.g., by a tensioner commercially available from Vytran, of Morganville, New Jersey, United States) at the cut point after cleaving. Window stripping can be achieved by laser stripping, hot nitrogen stripping, plasma stripping, or chemical stripping, for example. About 650 grams of force was used to mechanically separate the hollow-core optical fiber 10 with the Vytran tensioner. FIG. 8A shows nano-perforations 82 in the coating 90 on the hollow-core optical fiber 10 prior to separation of the hollow-core optical fiber 10 along the nano-perforations 82. FIG. 8B shows a cleaved fiber end face 84 of the hollow-core optical fiber 10 after the hollow-core optical fiber 10 was window-stripped and mechanically separated. FIG. 8C is a side view of the cleaved fiber end face 84 of hollow-core optical fiber 10 after the hollow-core optical fiber 10 was window-stripped and mechanically separated.

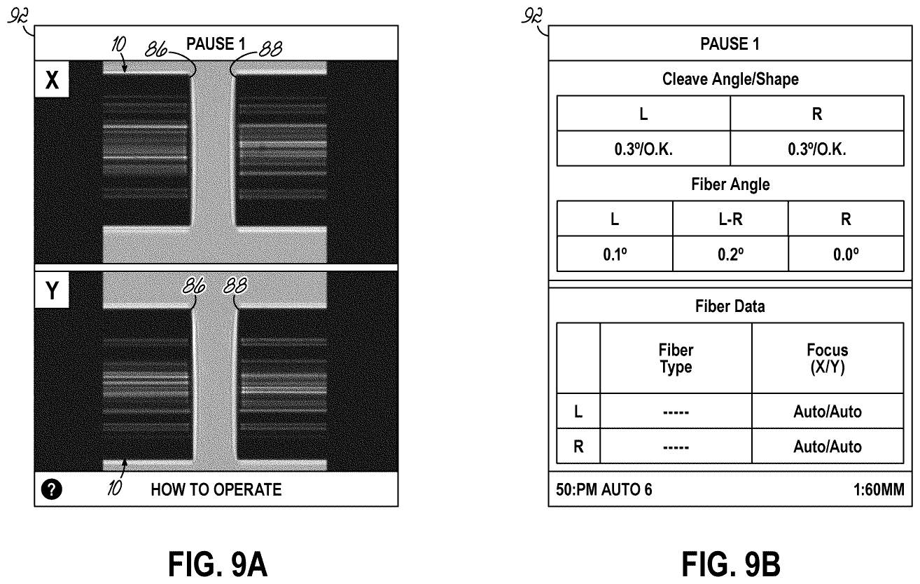

FIGS. 9A and 9B depict screenshots 92 of a fusion splicer showing an anti-resonant hollow-core optical fiber 10 prior to splicing. The arc discharge FSM-100P+ fusion splicer used to fusion splice the hollow-core optical fiber 10 is commercially available from Fujikura. The parameters used to fusion splice the hollow-core optical fiber 10 are shown in Table II below.

TABLE II
FUSION SPLICER PARAMETERS

| Prefuse | STD-150 | |
|---|---|---|
| Main arc | STD-110 | |
| Overlap | 15 | μm |
| Main arc time | 3 | S |

No clocking function to match structural tubes 14 was applied. In one instance, using the parameters noted above in Table II to splice together laser cleaved hollow-core optical fibers resulted in an insertion loss of only 0.41 dB for a system transmitting an optical signal having a wavelength of less than 1310 nm.

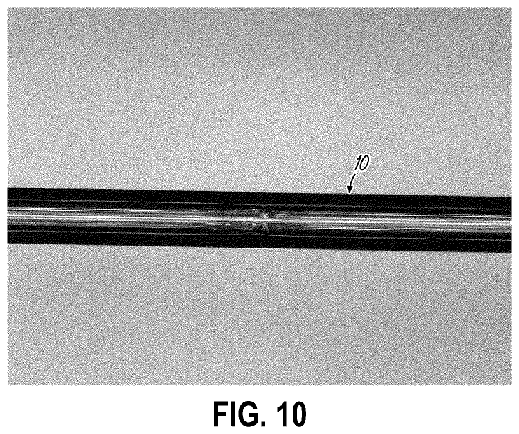

FIG. 10 depicts the anti-resonant hollow-core optical fiber 10 of FIGS. 9A and 9B after fusion splicing. The tension strength was tested using a rotary fiber proof tester (specifically, a PTR302 commercially available from Thorlabs, Inc. of Newton, New Jersey, United States) with a peak force of 2.62 lbs. The breakage point did not happen at the splice joint but instead at a point 9 mm away from the splice joint. Any potential damage, residuals, contaminations of the bare hollow-core optical fiber 10 after stripping could have impacted the tension strength of the hollow-core optical fiber 10.

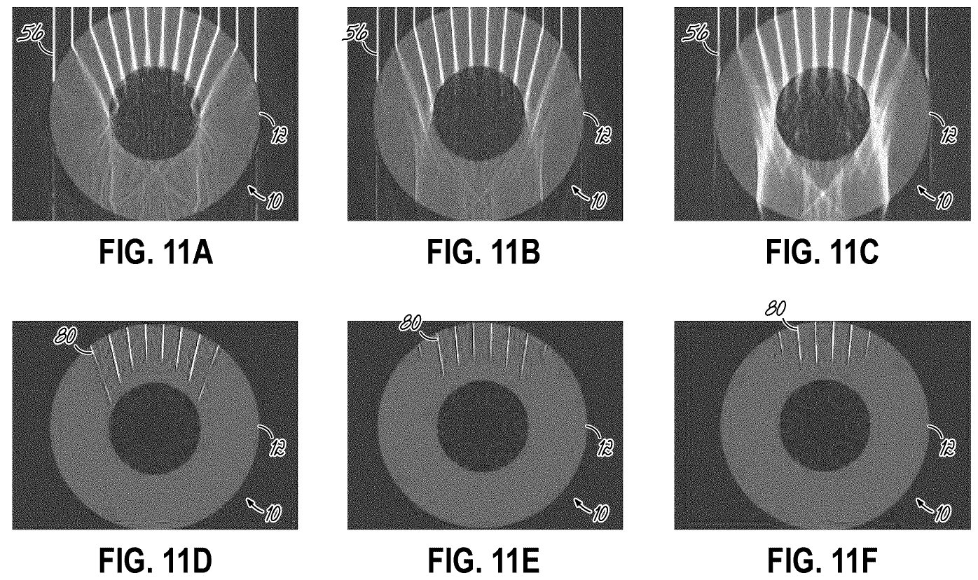

FIGS. 11A-11F depict simulated secondary Bessel beams 56 as they propagate into and through a computer model of an exemplary hollow-core optical fiber 10 (FIGS. 11A-11C) and simulated locations of nonlinear absorption 80 in the hollow-core optical fiber 10 (FIGS. 11D-11F) at a cleave angle of 3 degrees (FIGS. 11A and 11D), 5 degrees (FIGS. 11B and 11E), and 10 degrees (FIGS. 11C and 11F). FIGS. 11A-11F show the location of the hollow-core optical fiber 10 with a dark gray background for air and lighter gray circular area for glass. The laser beam angle used to achieve the angled cleave is in the direction of the page and cannot be seen. The size of the absorption region decreases as cleaving angle increases due to increased aberrations in the laser beam. Thus, as the cleave angle increases, the penetration of the absorption region in the hollow-core optical fiber 10 decreases, which may reduce the consistency and quality of the cut. The decreasing region of nonlinear absorption at high cleaving angles may make cleaving difficult and inconsistent. The simulation shows that angles between 0 and 3 degrees may result in a consistent cleaving quality, but the region decreases significantly for angles greater than 5 degrees. Increasing the pulse energy can help mitigate this effect somewhat by increasing the nonlinear absorption area. However, higher pulse energy may result in increased damage in the areas where laser beam aberrations are weak and may result in a poor quality cleave due to over-damaging the hollow-core optical fiber 10 in those areas.

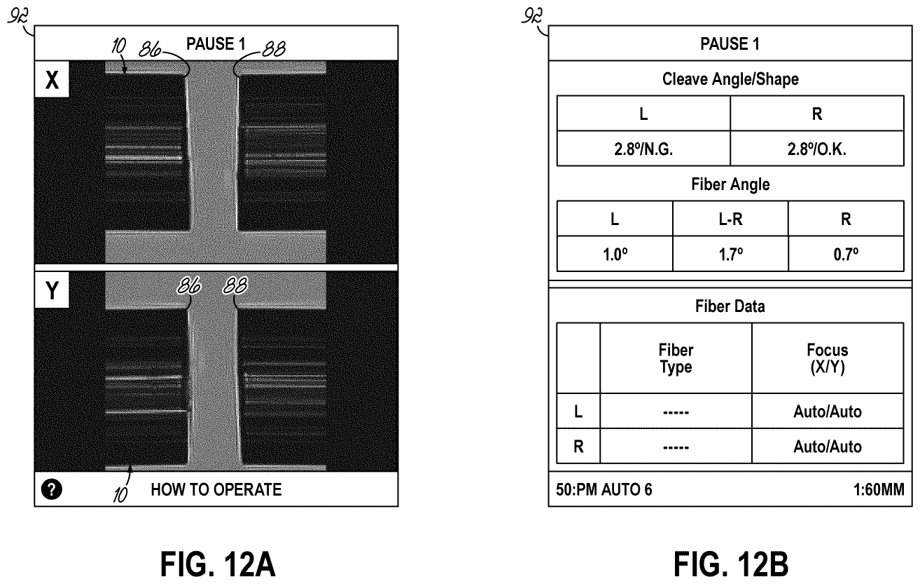

FIGS. 12A and 12B depict additional screenshots 92 of a fusion splicer. Specifically, the fusion splicer is being used to check the cleave angle of two laser cleaved angled hollow-core optical fibers 10 based on the intensity profile of the left side fiber tip 86 and the right side fiber tip 88. The particular fusion splicer used is an FSM 100P fusion splicer commercially available from Fujikura. As shown in FIG. 12B, the angles of the hollow-core optical fibers 10 are 2.8 degrees—which is close to the 3 degree designed angle. These angle cleaved hollow-core optical fibers 10 were separated by applying tension by hand after cleaving, which has demonstrated good consistency in comparison to using a mechanical tensioner.

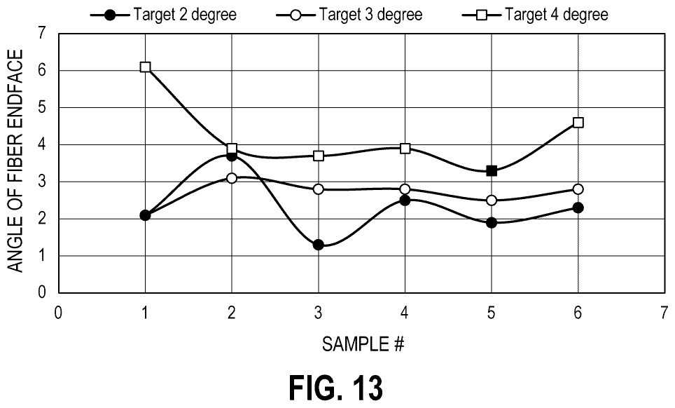

FIG. 13 depicts a graph showing data for laser cleaved hollow-core optical fibers 10 through cladding 12 versus designed angle. To identify the laser angle cleaving repeatability, a series of hollow-core optical fiber samples were laser cleaved with designed angles of 2 degrees, 3 degrees, and 4 degrees. Their measured angles are plotted in FIG. 13. As shown, higher angle cleaves (e.g., greater than 5 degrees) may be more difficult to achieve.

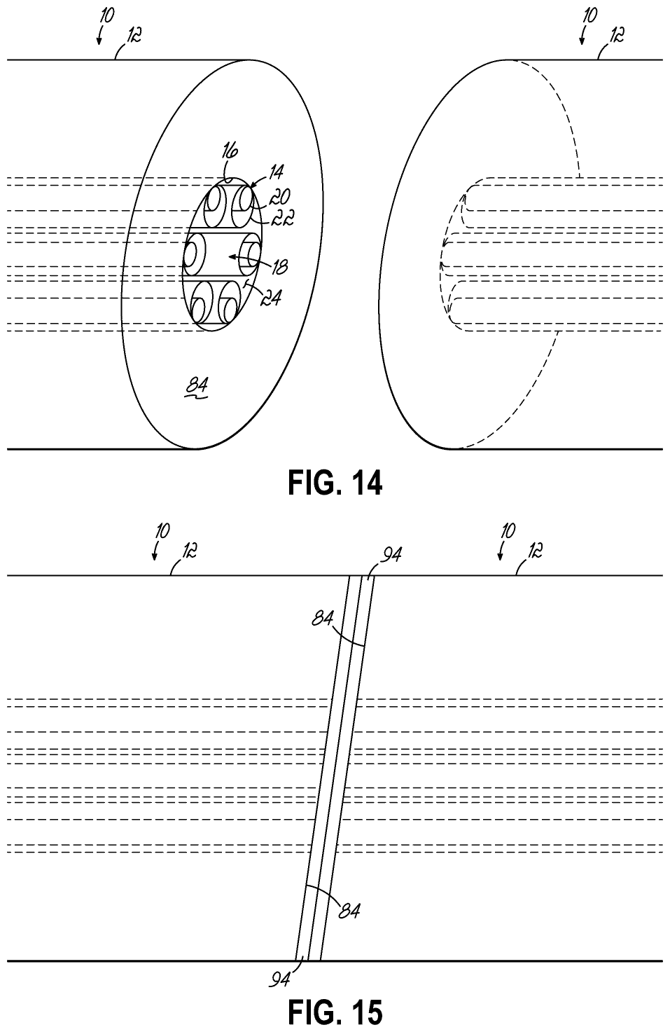

FIG. 14 depicts hollow-core optical fibers 10 cleaved in the same configuration (e.g., at the same angle) being connected by aligning the end face angle and the hollow-core pattern. Specifically, the hollow-core optical fibers 10 in FIG. 14 are low loss double nested anti-resonant nodeless hollow-core optical fibers. The hollow-core optical fiber 10 is preferably oriented such that mirror symmetry axis of the hollow-core patten is aligned to the angle pivot axis of the cleave plane. Furthermore, when terminated in a connector, the features of the structural tube 14 on the pivot axis are also preferably aligned to the connector key. As shown in FIG. 14, a benefit of this arrangement is that hollow-core optical fibers 10 cleaved and terminated in this convention can be mated with the cleave angle and the hollow-core pattern simultaneously aligned to obtain low insertion loss.

FIG. 15 depicts cleaved hollow-core optical fibers 10 with polished thin end caps 94 connected by physical contact. Hollow-core optical fibers 10 with an ultrathin end cap 94 can achieve physical contact (e.g., with another portion of a hollow-core optical fiber 10 with an ultrathin end cap 94) without using anti-reflection coatings. The fusion spliced coreless glass rod that makes up the end cap 94 can be polished to an extremely small thickness, such as 10 μm. The thickness can be monitored using interferometry. Conventional processes for bonding thin glass (e.g., the end cap 94) on the cleaved fiber end face 84 of the hollow-core optical fiber 10 may be unable to obtain a profile that matches that of the cladding 12. However, the end cap 94 surface can be polished to a slightly convex profile. Insertion loss is minimized with the thin end caps 94, which reduces the non-guided propagation distance and the lateral offset introduced by the angled end caps 94.

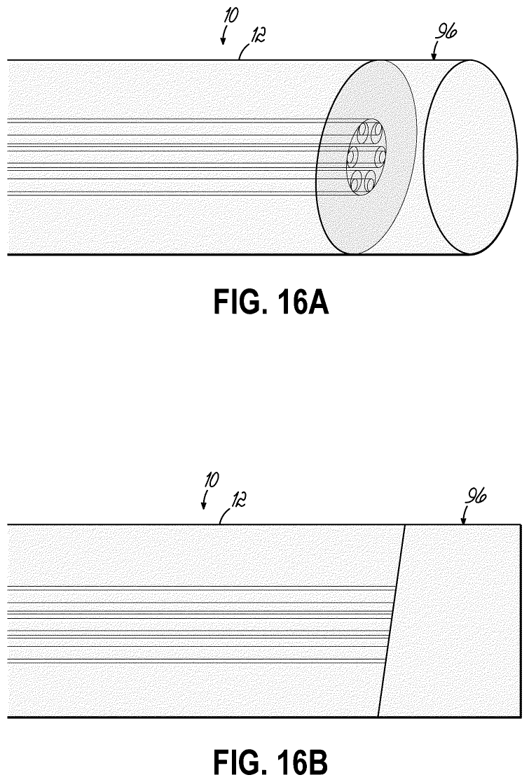

FIGS. 16A and 16B depict hollow-core optical fiber 10 with an angled cleave that is spliced to an angled solid-core optical fiber 96. Because hollow-core optical fiber 10 guides light in air, the transition to solid-core optical fiber 96 may have reflection loss at the glass/air interface. Angled interfaces and anti-reflection coatings may reduce the reflection loss. However, anti-reflection coatings may have difficulty surviving the high temperatures of the splicing process, so angled interfaces may provide a more feasible way to control reflection loss in interconnections between hollow-core optical fibers 10 and solid-core optical fibers 96. Alternatively, the solid-core optical fiber 96 can be designed as a coreless fiber for sealing an end of the hollow-core optical fiber 10 or function as a GRIN lens using a graded index fiber.

Hollow-core optical fiber 10 that guides light in air typically has high reflection loss at a flat interface between air and glass when splicing with a solid-core optical fiber 96, so an angled interface between air and glass in a hollow-core optical fiber 10 and single-mode optical fiber interconnection may be needed to meet transmission and reflection loss requirements. Splicing hollow-core optical fiber 10 with solid-core optical fiber 96 enables interconnection with single-mode optical fiber having a mismatched mode field diameter (MFD) as well as reflection loss at the interface between glass and air. Splicing angled solid-core optical fiber 96 (either coreless optical fiber or graded index optical fiber) with a hollow-core optical fiber 10 having the same cleave angle can reduce the reflection loss to less than −40 dB. By precisely controlling the interface angle to 2 degrees or 3 degrees, a balance can be struck between having a transmission loss less than 1 dB and a low reflection loss.

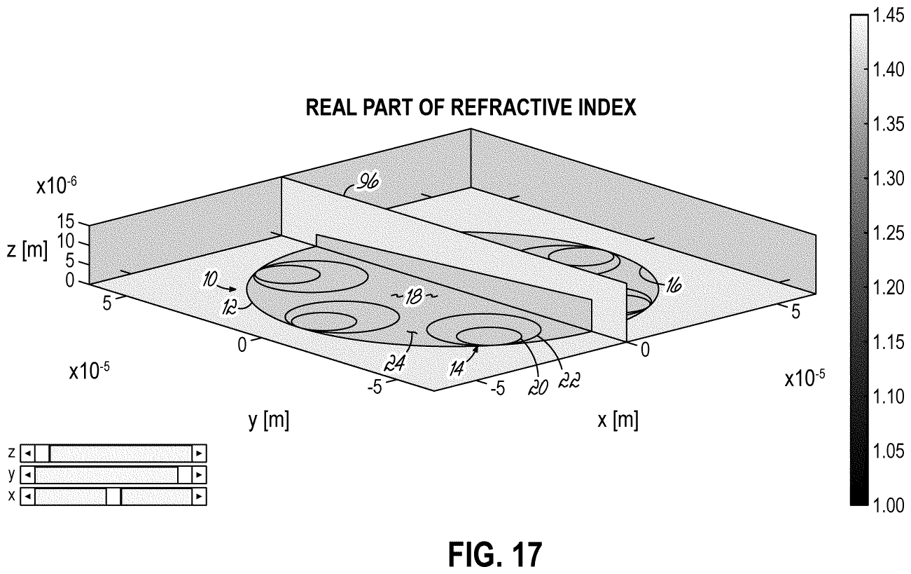

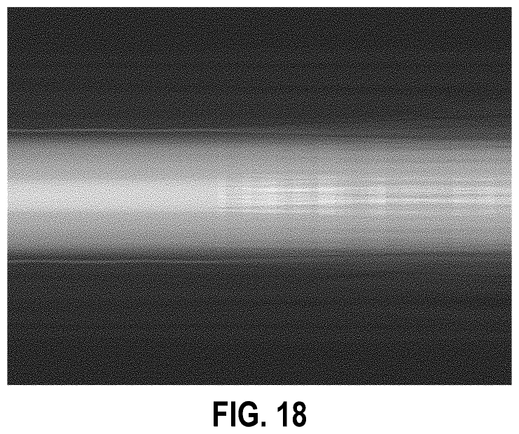

FIG. 17 depicts a 3 degree angled interface refractive index profile between a hollow-core optical fiber 10 and a solid-core optical fiber 96. FIG. 18 shows beam propagation (or propagation loss) in a segment of the interface of FIG. 17. The propagation loss in the angled interface segment was found to be 0.034 dB for a 3 degree angled interface when the solid-core optical fiber thickness is 15 μm.

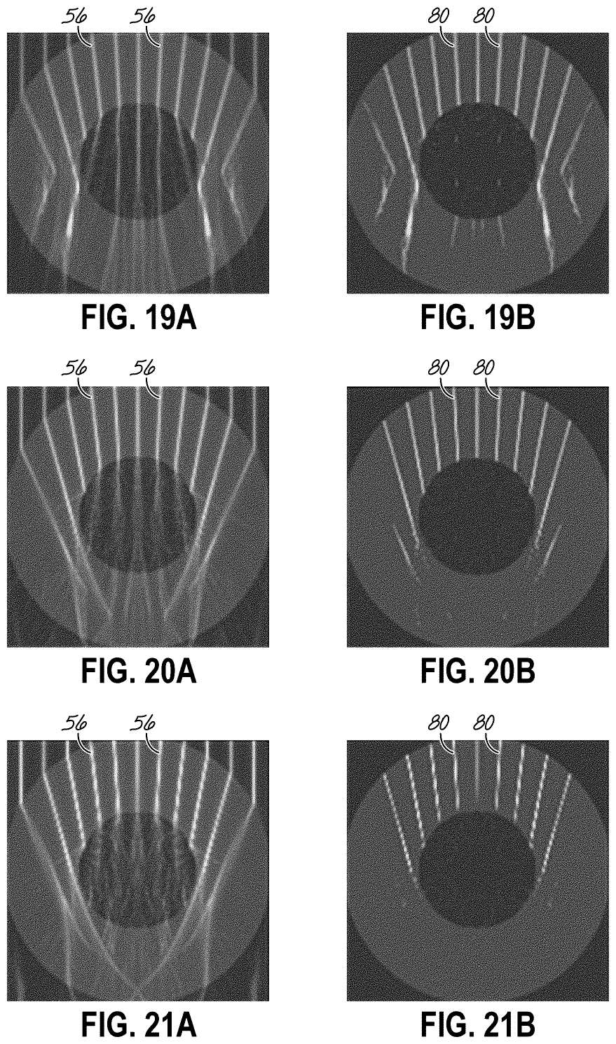

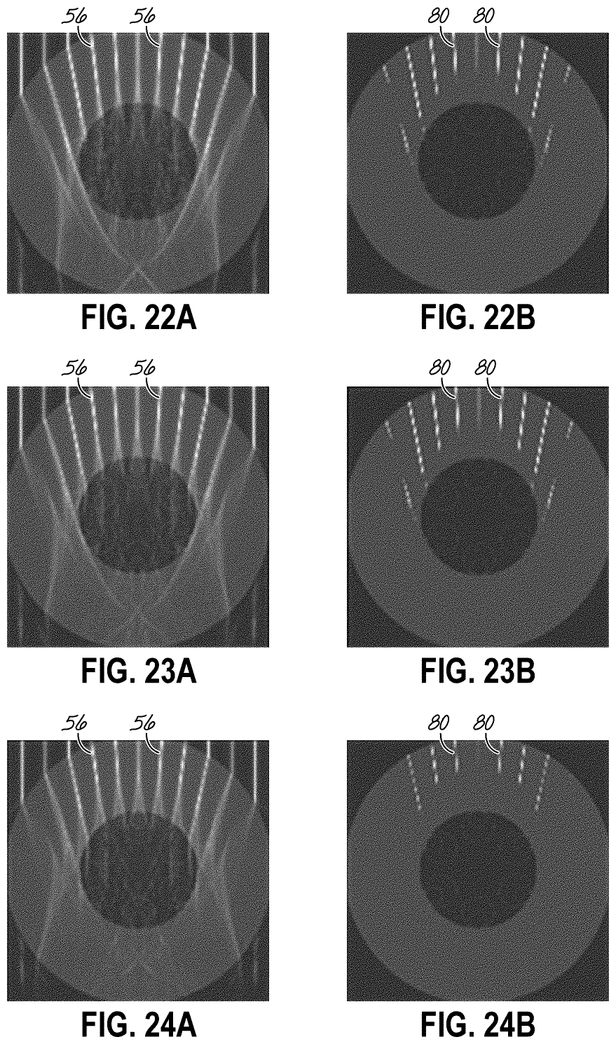

FIGS. 19A-24B depict cross-sectional views of a hollow-core optical fiber showing the results of simulated nano-perforation processes generated for focusing angles θ_{f} of 6 degrees (FIGS. 19A and 19B), 12 degrees (FIGS. 20A and 20B), 18 degrees (FIGS. 21A and 21B), 24 degrees (FIGS. 22A and 22B), 30 degrees (FIGS. 23A and 23B), and 36 degrees (FIGS. 24A and 24B). The figures show fiber location with a dark gray background for air and lighter gray circular area for glass. FIGS. 19A, 20A, 21A, 23A, and 24A show simulated secondary Bessel beams 56 as they propagate into and through a computer model of the hollow-core optical fiber, and FIGS. 19B, 20B, 21B, 23B, and 24B show simulated locations of nonlinear absorption 80 in the hollow-core optical fiber.

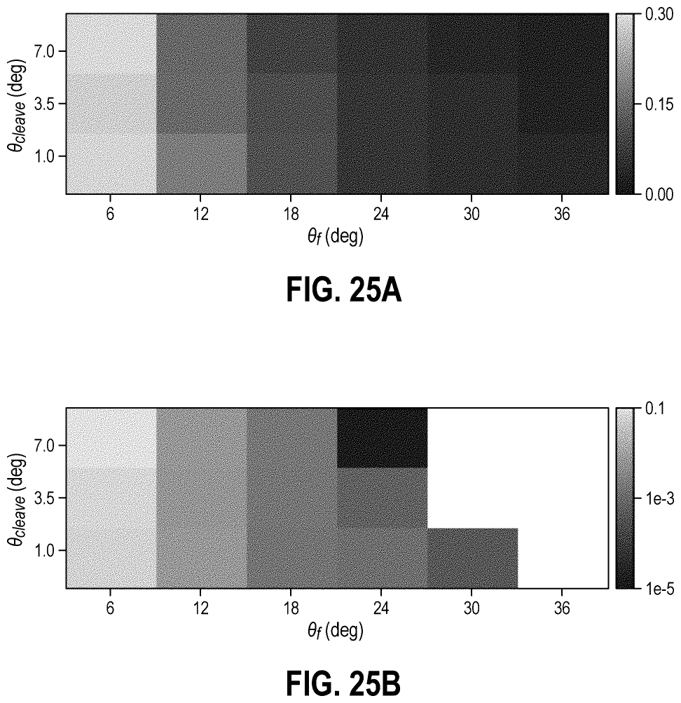

FIG. 25A depicts a graph showing the fraction of the cladding area experiencing nonlinear absorption, and 25B depicts a graph showing the fraction of the core region area experiencing nonlinear absorption for different combinations of cleave angle θ_{cleave} and focusing angle θ_{f}. The graph depicted by FIG. 25B has a log scale in which blank areas indicate that no nonlinear absorption occurred in the core region at those combinations of cleave angle θ_{cleave} and focusing angle θ_{f}. The cladding absorption area was estimated from the data used to generate the graphs of FIGS. 19B, 20B, 21B, 23B, and 24B by presuming that the full area between absorbing sections of the secondary Bessel beam would be absorbed due to a lower pitch between repetitions when cleaving the hollow-core optical fiber 10.

As can be seen from the simulation data, decreasing the focusing angle θ_{f} leads to a tradeoff between increased core region damage and increased cleaving area. The optimum focusing angle θ_{f} may be the focusing angle θ_{f} that provides sufficient area for cleaving while minimizing damage to the core region. For some applications, no damage to the core region may be acceptable. These zero-tolerance for damage applications may include geometry measurement using a scanning electron microscope or high mag microscope followed by image processing. Some damage may be acceptable in other situations, such as for splicing of hollow-core optical fibers. The cleaving angle θ_{cleave} can also influence the optimum focusing angle θ_{f}, with higher cleaving angles θ_{cleave} typically benefiting from lower focusing angle values to maintain a large cutting area. Higher cleaving angles cleave may also require larger cutting areas to ensure that the cleave follows the angled facet through the thickness of the optical fiber. This technique may be used to enable higher cleaving angles when cleaving hollow-core optical fibers and to ensure core region damage is low.

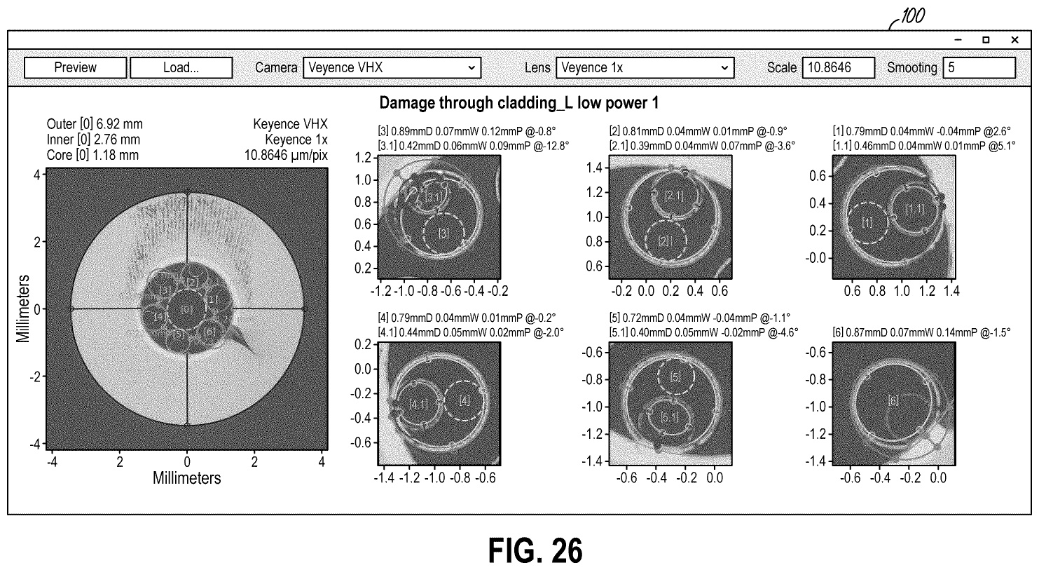

FIG. 26 depicts an exemplary user interface 100 of a structure analysis tool that may be used for geometry measurement of laser cleaved hollow-core optical fibers based on images captured by a digital microscope. Damaged capillaries may confuse conventional image processing algorithms, resulting in large variations in edge fitting for inner/outer capillaries. Scanning electron microscope images may provide higher resolution, but may also have longer turn-around times.

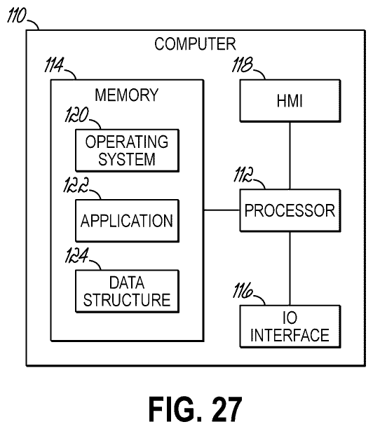

Referring now to FIG. 27, embodiments of the invention described above, or portions thereof, may be implemented using one or more computer devices or systems, such as exemplary computer 110. The computer 110 may include a processor 112, a memory 114, an input/output (I/O) interface 116, and a Human Machine Interface (HMI) 118. The processor 112 may include one or more devices that manipulate data based on operational instructions stored in memory 114. Memory 114 may include a single memory device or a plurality of memory devices capable of storing data. The processor 112 may operate under the control of an operating system 120 that resides in memory 114 and manages computer resources so that computer program code embodied as one or more computer software applications, such as an application 122 residing in memory 114, may have instructions executed by the processor 112. One or more data structures 124 may also reside in memory 114, and may be used by the processor 112, operating system 120, or application 122 to store or manipulate data. The I/O interface 116 may provide a machine interface that operatively couples the processor 112 to other devices and systems to enable the application 122 to provide the various features and functions comprising embodiments of the invention. The HMI 118 may be operatively coupled to the processor 112 of computer 110 to allow a user to interact directly with the computer 110, and may include one or more devices capable of providing data to and accepting data from the user.

In general, the routines executed to implement the embodiments of the invention may be referred to herein as “program code.” Program code typically comprises computer-readable instructions that are resident at various times in various memory and storage devices in a computer that, when read and executed by one or more processors in the computer, cause that computer to perform the operations necessary to execute operations embodying the various embodiments of the aspects of the invention. The program code embodied in any of the applications described herein is capable of being distributed as a computer program product in a variety of different forms, and may be distributed using a non-transitory computer-readable storage medium having computer-readable program instructions thereon.

While the present disclosure has been illustrated by the description of specific embodiments thereof, and while the embodiments have been described in considerable detail, it is not intended to restrict or in any way limit the scope of the appended claims to such detail. The various features discussed herein may be used alone or in any combination within and between the various embodiments. Additional advantages and modifications will readily appear to those skilled in the art. The present disclosure in its broader aspects is therefore not limited to the specific details, representative apparatus and methods and illustrative examples shown and described. Accordingly, departures may be made from such details without departing from the scope of the present disclosure.

What is claimed is:

1. A method of cleaving an optical fiber, comprising:
generating a non-diffracting beam configured to perforate the optical fiber;
scanning the non-diffracting beam across the optical fiber such that a plurality of perforations are created in the optical fiber that define a perforation plane in the optical fiber; and
applying a force across the perforations such that the optical fiber breaks along the perforation plane to form a cleaved fiber end face.

2. The method of claim 1, wherein the non-diffracting beam is a Bessel beam, and generating the non-diffracting beam includes:
generating a primary Bessel beam in an object space by passing a laser beam through an axicon lens having a deflection angle; and
generating a secondary Bessel beam by forming an image of the primary Bessel beam in an image space,
wherein the secondary Bessel beam provides the non-diffracting beam.

3. The method of claim 2, wherein the secondary Bessel beam has a focusing angle, and further comprising:
controlling a depth of the perforations in the optical fiber by adjusting the focusing angle of the secondary Bessel beam.

4. The method of claim 3, wherein:
the primary Bessel beam is imaged by a telescope having a collector lens with a first focal length and an objective lens with a second focal length, and
adjusting the focusing angle includes adjusting one or more of the first focal length of the collector lens, the second focal length of the objective lens, a beamwidth of the laser beam received by the axicon lens, and the deflection angle of the axicon lens.

5. The method of claim 4, wherein the adjusting the focusing angle further includes:
adjusting one or both of a first distance between the collector lens and the axicon lens, and a second distance between the objective lens and the collector lens.

6. The method of claim 3, wherein:
the axicon lens is part of an optical assembly including a telescope that forms the image of the primary Bessel beam in the image space, and
scanning the non-diffracting beam across the optical fiber includes at least one of moving the optical assembly relative to the optical fiber and moving the optical fiber relative to the optical assembly.

7. The method of claim 1, wherein scanning the non-diffracting beam across the optical fiber to define the perforation plane in the optical fiber includes:
pulsing the non-diffracting beam at a repetition rate; and
laterally translating the optical fiber across the non-diffracting beam at a speed such that adjacent perforations of the plurality of perforations connect to form the perforation plane.

8. The method of claim 1, wherein the optical fiber includes an optical axis, and the perforation plane is oriented at an angle within a range of 0 to 10 degrees to a plane perpendicular to the optical axis of the optical fiber.

9. The method of claim 1, wherein the optical fiber is a hollow-core optical fiber.

10. The method of claim 1, wherein the optical fiber includes one or more of a coating and a cladding, and the perforations are formed through the one or more of the coating and the cladding.

11. The method of claim 1, wherein the non-diffracting beam has a wavelength between 500 nanometers and 1100 nanometers, a pulse width between 2 picoseconds and 15 picoseconds, and a repetition rate between 5 kilohertz and 1 megahertz.

12. A system for cleaving an optical fiber, comprising:
a laser configured to output a laser beam having a pulse width and a repetition rate;
an optical assembly configured to receive the laser beam and output a non-diffracting beam;
one or more translation stages configured to move at least one of the optical assembly relative to the optical fiber and the optical fiber relative to the optical assembly; and
a computer operatively coupled to the laser and the one or more translation stages, the computer being configured to:
cause the laser to selectively output the laser beam having the pulse width and the repetition rate, and
cause the one or more translation stages to scan the non-diffracting beam across the optical fiber such that a plurality of perforations are created in the optical fiber that define a perforation plane in the optical fiber.

13. The system of claim 12, wherein the optical assembly includes:
a telescope having an object space and an image space; and
an axicon lens that receives the laser beam and outputs a converging conical wavefront that defines a primary Bessel beam in the object space of the telescope,
wherein the telescope is configured to form a secondary Bessel beam in the image space that provides the non-diffracting beam.

14. The system of claim 13, wherein the telescope includes:
a collector lens that faces the object space and has a first focal length; and
an objective lens that faces the image space and has a second focal length.

15. The system of claim 14, wherein the second focal length is longer than the first focal length.

16. The system of claim 14, wherein the collector lens is spaced from the objective lens by a distance equal to a sum of the first focal length and the second focal length, the collector lens is spaced from the primary Bessel beam by the first focal length, and the secondary Bessel beam is spaced from the objective lens by the second focal length.

17. The system of claim 12, wherein the optical fiber has an optical axis, and further comprising:
a goniometric stage configured to tilt the optical fiber along the optical axis so that the perforation plane is oriented at an angle within a range of 0 to 10 degrees to a plane perpendicular to the optical axis of the optical fiber.

18. The system of claim 12, wherein the non-diffracting beam has a wavelength between 500 nanometers and 1100 nanometers, the pulse width is between 2 picoseconds and 15 picoseconds, and the repetition rate is between 5 kilohertz and 1 megahertz.

19. The system of claim 12, wherein the one or more translation stages includes a first translation stage that moves the optical assembly relative to a fixed reference frame, and a second translation stage that moves the optical fiber relative to the fixed reference frame.

20. The system of claim 12, wherein the first translation stage is a single-axis translation stage that moves the optical assembly longitudinally towards and away from the optical fiber, and the second translation stage is a two-axis translation stage that moves the optical fiber laterally relative to the optical assembly.
